(19) United States
(12) Patent Application Publication
(10) Pub. No.: US 2007/0295815 A1
(43) Pub. Date: Dec. 27, 2007

(54) Counter with Communication Function

(75) Inventors: Yutaka MORIWAKI, Plano, TX (US); Shoichiro TAKASAKI, Plano, TX (US)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/763,325

(22) Filed: Jun. 14, 2007

(30) Foreign Application Priority Data
Jun. 27, 2006 (JP) 2006-175991

(51) Int. Cl. G06K 7/10; G06M 1/06

(52) U.S. Cl. 235/462.01; 235/103

(57) ABSTRACT

A counter with communication function allows the counts of a counting mechanism to be transmitted through a communication line such as the Internet, so that no meter reading by a meter reader is required. A CPU of a control unit checks the time given in a timer and determines whether the current time and date is the date and time to transmit counts. It drives a bar code reader when it is the date and time to transmit the counts, and the bar code reader reads the counts of a counting mechanism of a copy machine and stores it in a memory. The CPU then gives a user or a management company notice of the read counts and counter information, such as a counter number, through a communication interface, a router and an Internet network by Electronic Mail.

### RELATED APPLICATIONS

This application claims priority under 35 USC 119 in Japanese application no. 2006-175991, filed on Jun. 27, 2006, the contents of which is hereby incorporated by reference in is entirety.

### BACKGROUND OF THE INVENTION

1. Field of the Invention

The present invention relates to a counter with a communication function that transmits the counts of a counting mechanism using a communication line such as the Internet.

2. Description of the Related Art

In a transaction in which payments are made depending on the amount of use of electricity, gas, and running water, for example, a meter reader checks the count of a meter equipped in individual households on a regular basis to know the amount of use. Such a meter is known as a watthour meter, a running water meter, a gas meter and so on, which typically transmits to a counting mechanism through a gear mechanism the motion of a detection unit such as a metal disk that is rotated by eddy current generated depending on the amount of current, or a rotating impeller wheel that corresponds to the fluid state of a fluid, and which indicates the numeric values of individual digits on a display part. A meter reader visually inspects the indication of the numeric values of the counting mechanism and issues a tally sheet including the amount of use and making a charge.

In addition, a mechanical counter is also provided in a copy machine in which a user of the copy machine can know the number of copies based on the counts of the mechanical counter. Moreover, a mechanical counter is also provided in a vending machine on a road to confirm the amounts of sales.

on the other hand, with the wide spread use of the Internet, the Internet Protocol (IP) is always embedded in in-house networks. Appliances that communicate in IP have a four byte IP address. The main function of IP is to provide routing that delivers packets from a source terminal to a destination terminal, during which it selects a network to transmit over and splits and assembles packets according to the transfer packet size for that network. The confirmation of loss or overlapping of packets is processed in a layer higher than IP.

As the coverage area of networks and the number of appliances that require IP addresses are increased, problems arise such as exhaustion of IP addresses and complicated routing. In particular, with regard to the IP addresses, a great problem arises in that the number of global addresses that can be used publicly are insufficient.

Therefore, the Internet Protocol version 6 (IPvG) protocol and network services are increasingly being adopted as the next-generation IP. The main feature of IPv6 is that the IPv6 address size is expanded to 16 bytes, and that the address structure is a hierarchical file system to facilitate routing. With the expansion of the IPvG address size, the global IPv6 addresses can be given to a personal computer, mobile terminals and household electrical appliances to implement Peer to Peer communications in which they can directly communicate with each other.

### SUMMARY OF THE INVENTION

As described above, in a system in which a meter reader checks the amount of use of services such as gas, electricity and running water with meters equipped in the individual households on a regular basis, it is necessary to check the meters equipped in the individual households one by one. Therefore, problems arise that it takes time to check meters, and that costs are increased because it is necessary to employ many meter readers. In addition, the counts of mechanical counters equipped in copy machines and vending machines must be visually inspected on a regular basis, causing a problem in increased effort.

In order to overcome the problems described above, an object of the present invention is to provide a counter with communication function in which IPv6, for example, is used to transmit the counts of a counter mechanism through a communication line such as the Internet, whereby meter reading by a meter reader can be eliminated.

In order to achieve this object, a counter with a communication function according to the invention includes: a counting mechanism, a communicating means connectable to the Internet, and a control means which transmits counts of the counting mechanism through the communicating means.

Moreover, the counter with communication function according to the invention is characterized by having a communicating means which holds an IPv6 address.

Moreover, in the counter with communication function according to the invention, the control means transmits the counts of the counting mechanism by Electronic Mail.

Since the counter with communication function according to the present invention transmits the counts of the counting mechanism by Electronic Mail through Internet connection means, no meter reader is required to confirm the amount of use of electricity, gas and running water, for example, and a user can easily confirm the counts of the mechanical counter of a copy machine, for example.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of a counter with a communication function according to an embodiment of the present invention.

FIG. 2 is a diagram depicting the structure of the counter with communication function of FIG. 1.

FIG. 3 is an enlarged diagram of a counting mechanism according to an embodiment of the invention.

FIG. 4 is a diagram of an exemplary overall system in which the counter with communication function according to an embodiment of the invention may be adapted.

FIG. 5 is a flow chart depicting the operations for transmission of the counts of the counter according to an embodiment of the invention.

### DETAILED DESCRIPTION OF EMBODIMENTS OF THE INVENTION

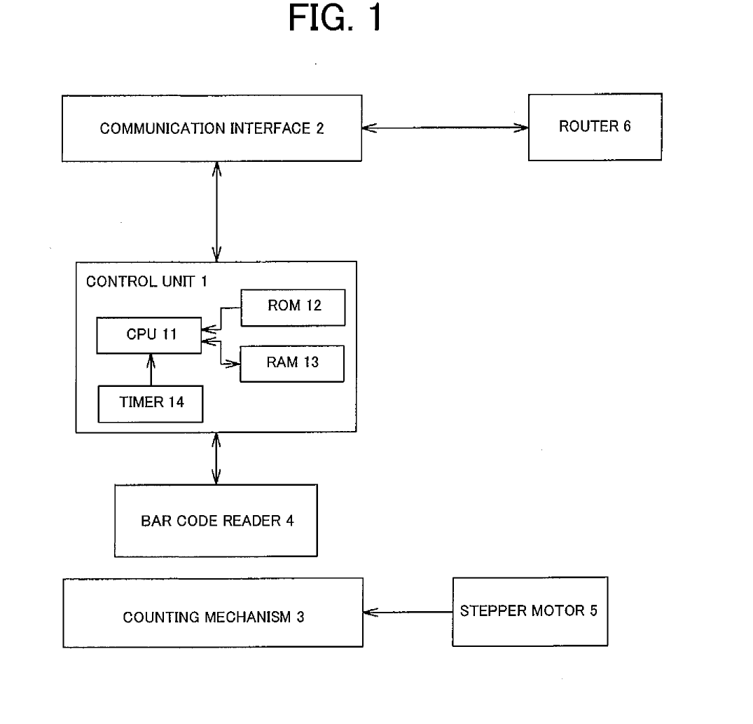

Hereinafter, an embodiment in which a counter with a communication function according to the invention is adapted to a gas meter is described. As illustrated in FIG. 1, the counter with communication function according to the invention comprises a control unit 1, a communication interface 2, a counting mechanism 3, a bar code reader 4, and a stepper motor 5 which drives the counting mechanism 3.

The control unit 1 comprises a CPU 11, a ROM (Read Only Memory) 12, a RAM (Random Access Memory) 13 and a timer 14. The CPU 11 controls the hardware of the control unit 1, the communication interface 2, and the bar code reader 4, and also performs a read program for the counts of the counting mechanism 3 based on the program stored in the ROM 12. The ROM 12 stores the read program, the destination Electronic Mail address of the counts of the counting mechanism 3 and information on the counter device, such as counter number and user information. The RAM 13 stores temporary data generated in executing the program and the IP address allocated to itself. The timer 14 keeps dates and time, and can comprise separate hardware. Alternatively, the CPU 11 may keep time by means of software.

The communication interface 2 connects the control unit 1 to a network through the router 6. The communication interface 2 is allocated an address in accordance with Internet Protocol version 6 (IPv6) having an address system that can identify the party on the other end even though a large number of devices are connected. The communication interface 2 transmits and receives data and control information to and from appliances (for example, a computer) connected to a network in accordance with the IPv6 communication protocol (protocol). The router 6 analyzes data conveyed through the network based on the protocol, and determines through which route data should be conveyed so as to set the data transfer route.

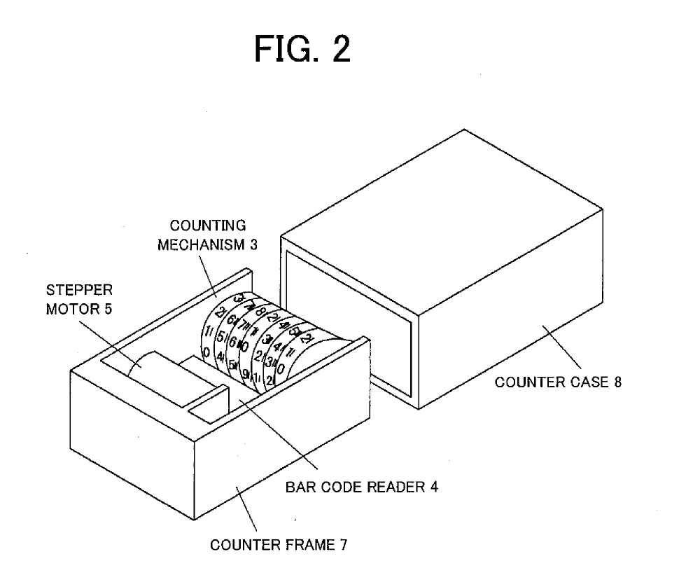

FIG. 2 depicts the counter with communication function according to the invention. As shown in FIG. 2, the counting mechanism 3, the bar code reader 4, and the stepper motor 5 are accommodated in a counter frame 7 and sealed with a counter case 8. In addition, an IC board (not shown) including the control unit 1 and the communication interface 2 is sealed inside the counter frame 7.

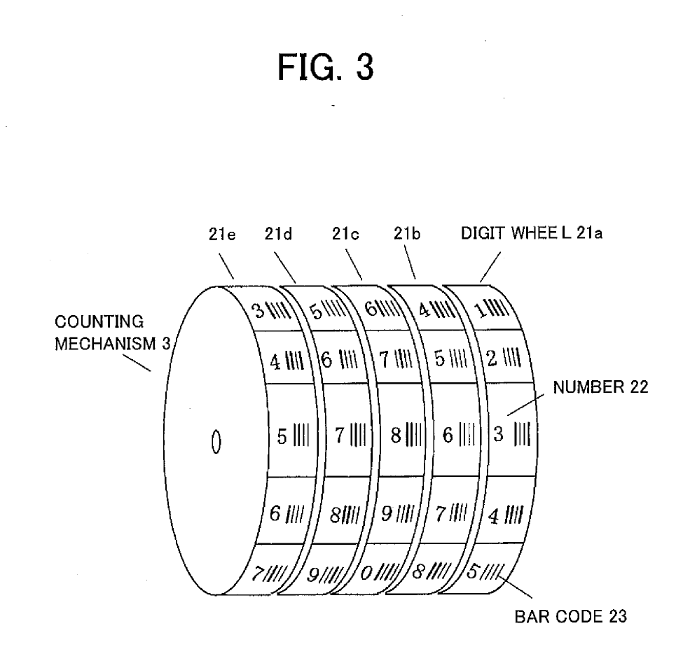

As illustrated in FIG. 3, the counting mechanism 3 is formed of a plurality of digit wheels 21a, 21b, 21c, 21d, and 21e. When the digit wheel 21a at the lowest decimal place makes a whole turn, the digit wheel 21b at the next higher digit is rotated at an angle of 36 degrees. In this manner, when the digit wheel at a lower decimal place makes a whole turn, the digit wheel at the next higher decimal place is rotated at an angle of 36 degrees. The rotation of the digit wheels can be implemented, for example, by the known structure using a gear train.

On the outer circumferential side of the individual digit wheels 21a, 21b, 21c, 21d, and 21e, numbers 22 (0-9) and bar codes 23 are indicated at intervals of a fixed angle. The bar code 23 is a bar code symbol corresponding to a number from 0-9. As with the numbers 22, the individual bar codes are arranged at intervals of 36 degrees, Each bar code symbol 23 is arranged with a gap between it and its associated number 22, corresponding to a gap between a window (not shown) of the case 8 for reading the number 22 and the read position of the bar code reader 4, so that the numeric value visible through the window matches with the numeric value read by the bar code reader 4.

As described above, the bar code 23 comprises visible marks. However, it may take alternative forms. For example, it may instead be an invisible code formed from magnetic coating over which the numbers 22 are printed, or an array of infrared light emitting fluorescent materials.

The bar code reader 4 is instructed by the control unit 1 to read the bar codes 23 indicated on the digit wheels of the counting mechanism 3. A bar code reader capable of photo-electric conversion is used when the bar codes are visible, whereas a bar code reader capable of magnetoelectric conversion is used when the bar codes are an array of a magnetic substance. A bar code reader capable of infrared photo-electric conversion is used when the bar codes are arrays of an infrared emitting fluorescent material.

The stepper motor 5 is driven by a drive pulse that is generated each time that 1 m³ of gas is passed. The stepper motor 5 transmits the rotation of a motor gear wheel to the digit wheel 21a at the lowest decimal place of the counting mechanism 3 through a speed reducing gear train (not shown), and rotates the digit wheel 21a to indicate the amount of gas passed through the counting mechanism 3.

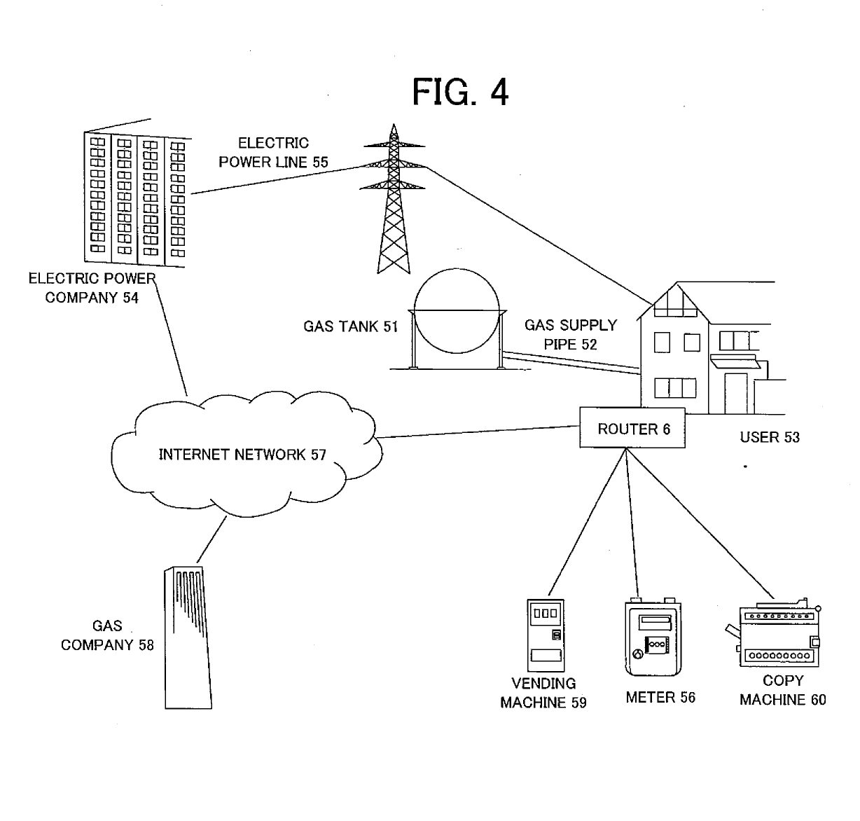

FIG. 4 illustrates an exemplary overall system to which the counter with communication function according to the invention may be adapted. As shown in FIG. 4, gas is supplied from a gas tank 51 to the buildings and houses of individual users 53 through a gas supply pipe 52, and electricity is supplied from an electric power company 54 to the buildings and houses of the individual users 53 through an electric power line 55. The counts of various meters 56 equipped in the building and houses of the individual users 53 are transmitted to a gas company 58 and the electric power company 54 through the router 6 and an Internet network 57. In addition, counters with a communication function according to the invention may be equipped, for example, in a vending machine 59 and a copy machine 60, and can transmit the counts to a management company, for example, through the router 6 and the Internet network 57.

As described below, the counter with communication function illustrated in FIG. 1 automatically acquires an address in IPv6. When a counter with communication function is connected to an IPv6 router 6, the communication interface 2 makes a request to the router 6 for the 64 bit number (also referred to as a prefix) that is allocated to the router and is unique thereto. When the prefix is transmitted, the control unit 1 generates a 64 bit number called an interface ID, and combines it with the prefix transmitted from the router to complete a 128 bit IP address in total. Then, the completed IP address is transmitted on LAN, it is checked whether there is any terminal device using the same IP address, and the completed IP address is set as the IP address of the counter when there is no other device with that address. When there is another such device, the numeric value of the interface ID is changed and again it is checked whether there is any such device. It is repeated until no such device is found, at which point the IP address is set and stored in the RAM 13.

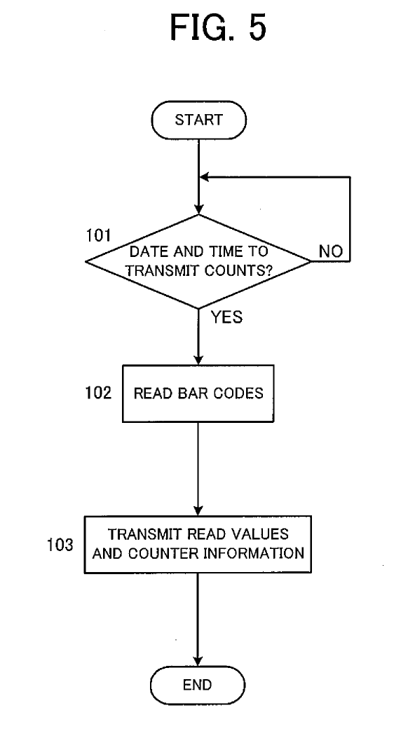

The operations for transmission of the counts of the counter with communication function are described with reference to FIG. 5. The CPU 11 of the control unit 1 continually performs a count transmission program, illustrated in the flow chart in FIG. 5, which determines whether the current time of day is the date and time to transmit the counts based on the time of the timer 14 (Step 101). For example, in the case in which it is configured to transmit the counts at 0:00 a.m. on the 20th day every month, the CPU 11 drives the bar code reader 4 at 0:00 a.m. on the 20th day, reads the counts of the counting mechanism 3, and stores it in the RAM 13 (Step 102). After that, it gives the gas company 58 notice of the read counts and counter information by Electronic Mail through the communication interface 2, the router 6, and the Internet network 57.

In other words, the CPU 11 reads out of the ROM 12 the destination to transmit the counts, for example, an Electronic Mail address of the gas company 58, generates the read counts and counter information, such as user name or gas meter number or text describing problems with the meter, and transmits Electronic Mail attached with the text data to the Electronic Mail address through the communication interface 2 and the router 6 using the SMTP protocol.

As described above, the counts of the counting mechanism 3 can be transmitted by Electronic Mail through the Internet network. Therefore, no meter reader is required to check the amount of use of electricity, gas and running water, for example, and the counts of the mechanical counter of a copy machine, for example, are transmitted directly to the user by Electronic Mail, whereby the counts can be easily confirmed with no visual inspection of the mechanical counter.

In addition, in the embodiment, attached files of Internet Electronic Mail are used to transmit information. However, a text format in a defined format and an encoded text format may be adapted. In addition, in the embodiment, the bar code reader is used to read the counts of the counting mechanism. However, the counts may be determined by counting the drive pulse of the stepper motor.

Moreover, in the embodiment, the case is described in which the counter with communication function according to the invention is adapted to a gas meter. However, it may be used for any of various appliances having a mechanical counter such as an electric power meter, a running water meter, a copy machine, a vending machine, etc. For example, in the case in which the rotation of a rotating disk is transferred to rotation of digit wheels as in the electric power meter, a mechanism is provided that generates a pulse every turn of the rotating disk, these pulses counted by the control unit so that the counts can be obtained.

In the case in which the counter according to the invention is used for the counter of a copy machine or a facsimile machine, the counter value can be sent to a user and a service management company by Electronic Mail.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A counter with communication function comprising:
a counting mechanism;
communicating means connectable to the Internet; and
control means which transmits counts of the counting mechanism through the communicating means.

2. The counter with communication function according to claim 1, wherein the communicating means holds an IPvG address.

3. The counter with communication function according to claim 1, wherein the control means transmits the counts of the counting mechanism by Electronic Mail.

4. The counter with communication function according to claim 2, wherein the control means transmits the counts of the counting mechanism by Electronic Mail.

5. The counter with communication function according to claim 1, wherein the counting mechanism comprises a plurality of digit wheels and a bar code reader.

6. The counter with communication function according to claim 5, wherein visible bar codes are formed on the digit wheels, and the bar code reader is capable of photo-electric conversion.

7. The counter with communication function according to claim 5, wherein bar codes of a magnetic substance are formed on the digit wheels, and the bar code reader is capable of magnetoelectric conversion.

8. The counter with communication function according to claim 5, wherein bar codes of an infrared emitting fluorescent material are formed on the digit wheels, and the bar code reader is capable of infrared photo-electric conversion.

9. The counter with communication function according to claim 5, and further comprising:
a stepper motor that drives the digit wheels.

10. The counter with communication function according to claim 9, wherein the stepper motor generates a drive pulse to drive the digit wheels each time 1 m³ of gas is passed.

11. The counter with communication function according to claim 1, and further comprising a timer, wherein the control means reads and transmits the counts of the counting mechanism when the timer reaches a specified time.

12. A method for transmitting counts of a counter comprising:
generating a count that is indicative of a usage amount of a product or service; and
at a specified time, automatically reading and transmitting the count via the Internet to a provider of the product or service.

13. The method according to claim 12, wherein a count is generated by driving digit wheels with a stepper motor.

14. The method according to claim 13, wherein the count is read by a bar code reader that reads bar codes on the digit wheels.

15. The method according to claim 13, wherein the count is determined by counting drive pulses generated by the stepper motor.

16. The method according to claim 12, wherein the count and counter information is transmitted by Electronic Mail.

17. The method according to claim 12, and further comprising automatically obtaining an IPv6 address for the counter.

18. The method according to claim 17, wherein the IPv6 is automatically obtained by:
making a request to an IPv6 router for a 64-bit prefix;
receiving the 64-bit prefix that is allocated to the router;
generating a 64-bit interface ID; and
combining the prefix and the interface ID to complete a 128-bit IPv6 address.

19. A counter with a communication function that is used in conjunction with a meter, comprising:
a communication interface;
a counting mechanism;
a reader that reads a count on the counting mechanism; and
a control unit that drives the reader to read the count at a specified time and to transmit the count via the communication interface and the Internet to a specified destination.

20. The counter according to claim 19, wherein the meter is selected from a group comprising a gas meter, an electric meter, a water meter, a copy machine meter and a vending machine meter.
